(19) United States
(12) Patent Application Publication
(10) Pub. No.: US 2026/0349383 A1
(43) Pub. Date: Nov. 5, 2026

(54) Light-Field Distribution Based Naked-Eye 3D Rendering Method, Apparatus, Parameter-Design Method and Display Device

(71) Applicant: CubeVi Inc., Palo Alto, CA (US)

(72) Inventors: Qi Luo, Beijing (CN); Jiuzhou Shao, Santa Clara, CA (US); Yan Zhang, Beijing (CN); Ruancun Li, Beijing (CN); Zeheng Zhang, Beijing (CN); Zhaohan Li, Beijing (CN)

(21) Appl. No.: 19/258,815

(22) Filed: Jul. 2, 2025

(30) Foreign Application Priority Data
Apr. 30, 2025 (CN) 202510574935.9

(51) Int. Cl. G03H 1/00; G03H 1/04; H04N 13/383

(52) U.S. Cl. CPC G03H 1/0005; G03H 1/0402; H04N 13/383; G03H 2001/0088; G03H 2001/0428

(57) ABSTRACT

A method and apparatus for naked-eye 3D rendering based on light-field distribution are disclosed. The method includes acquiring parameters of a naked-eye 3D display device, constructing a light-field distribution model, obtaining real-time eye coordinates of a viewer, and computing an equivalent lens pitch and offset. Based on these values, the system determines rendering parameters, arranges and reorders viewpoints, and generates a light-field image for projection onto a display screen. A human-eye characteristic model may be used to weight rendering parameters via Fourier transform or Gaussian convolution. The apparatus includes a data acquisition unit, a control module, and a display device configured to implement the method.

### CROSS-REFERENCE TO RELATED APPLICATION

This application claims priority under 35 U.S.C. § 119 (a) to Chinese Patent Application No. 202510574935.9, filed on Apr. 30, 2025, the entire disclosure of which is hereby incorporated by reference in its entirety.

### TECHNICAL FIELD

The present invention relates to the fields of naked-eye 3D rendering and holographic imaging, and in particular to a naked-eye 3D rendering method, device, parameter-design method and display equipment based on light-field distribution.

### BACKGROUND

Existing naked-eye 3D rendering methods typically simulate multiple virtual cameras capturing a 3D scene from different angles, rendering each view at the same resolution. During the rendering process, the 3D scene is projected onto a 2D plane based on the world-coordinate projection relationships of the 3D model and the display-screen coordinates.

Some current naked-eye 3D display methods rely on two views (left and right) and use eye-tracking to align these views after refraction through a lenticular array. However, when the tracked eye coordinates deviate from the viewer's actual eye position, mismatches between expected and perceived view positions may occur, often resulting in viewer discomfort such as dizziness. Other approaches divide the lenticular array into multiple discrete viewing zones and periodically tile views across these zones. In such systems, when a viewer's eye crosses the boundary between zones, visual discontinuities or distortion in the 3D image may occur. Furthermore, distributing light across multiple zones increases the equivalent pixel pitch between views, which reduces both resolution and perceived image clarity.

In summary, existing naked-eye 3D rendering and display methods suffer from the following drawbacks:

1. Low resolution and poor image clarity: Increasing resolution without significantly raising cost remains a persistent challenge in the design of naked-eye 3D displays.

2. Sensitivity to tracking errors in binocular systems: Eye-tracking-based systems demand high temporal precision. Mismatches between the tracked and actual eye positions can result in dizziness, and optical effects such as angular resolution limits or aberrations can cause overlap between left- and right-eye views.

3. 3D image distortion across viewing zones: Multi-viewpoint systems may produce visible distortion when the viewer's eye transitions across zone boundaries. The inherent spatial resolution limits of lenticular or grating structures often lead to blurring and visual fatigue.

4. Inefficient rendering resource usage: Rendering dozens of virtual camera views at uniform resolution consumes significant computational resources, especially as the number of viewpoints increases, leading to substantial inefficiencies.

In view of the foregoing, the present invention provides a naked-eye 3D rendering method, apparatus, parameter-design method, and display device based on light-field distribution. The invention is designed to address and overcome the problems of low resolution, poor clarity, dizziness, view jumping, view overlap, and in-out-of-screen image distortion associated with existing naked-eye 3D rendering and display systems.

### SUMMARY

The present invention provides systems and methods for naked-eye three-dimensional (3D) rendering based on light-field distribution, aimed at improving display clarity, resolution, viewing stability, and computational efficiency across a wide range of viewing conditions.

In one aspect, a method is provided for generating naked-eye 3D content by acquiring parameters of a 3D display device, including both two-dimensional (2D) display and optical-structure parameters. A light-field mapping relation is derived from the optical parameters, and a corresponding light-field distribution model is constructed. Real-time viewer eye coordinates are obtained and used to compute an equivalent lens pitch and equivalent offset of the optical structure. Based on these values, the system determines a reference viewing region and its angular range, calculates the number of required virtual cameras, and determines rendering parameters for generating viewpoint-dependent subviews. Viewpoints are arranged and reordered to form a viewpoint map, which is interleaved according to a rendering model to produce a light-field image projected onto the display screen.

In another aspect, the method includes generating a human-eye characteristic model based on perceptual features such as visual sensitivity and chromatic aberration. Fourier transform or Gaussian convolution is applied to this model to obtain spatial weights or convolution kernels that are used to update rendering parameters. These perceptually weighted parameters enable more accurate rendering at reduced computational cost, while mitigating issues such as ghosting and crosstalk.

The method also includes steps for dynamically adjusting the number of subviews based on changes in the viewer's eye position, recalculating the equivalent lens pitch and viewpoint layout as necessary. Viewpoints are spatially rearranged to align with the viewer's gaze, ensuring consistent 3D perception even when the viewer moves beyond nominal viewing zones.

In another aspect, a method is provided for designing the angular pitch of the light-field screen in a naked-eye 3D display device. This includes computing a suitable design pitch based on screen size, viewer distance, interpupillary distance, optical manufacturing tolerances, system latency, and modeled eye movement behavior.

The invention also provides an apparatus for implementing the light-field rendering method. The apparatus includes a data acquisition unit, a control module, and a display device. The control module builds the necessary models and generates the light-field image using the acquired parameters and real-time viewer data. The display device renders the light-field image to produce a glasses-free 3D or holographic display.

Additional features of the apparatus include computation of the equivalent lens pitch and offset, determination of rendering parameters for virtual cameras or pre-encoded video textures, dynamic arrangement and reordering of subviews, and organization of subviews into storage formats such as quilt images, multi-view disparity coding, or texture arrays.

The control module may further include functionality to transform the viewer's eye coordinates into an observation-space coordinate system and adapt rendering parameters accordingly, ensuring spatial consistency and perceptual alignment across different viewing conditions.

Finally, a naked-eye 3D display device is also disclosed, including a 2D display panel or light source, an optical structure capable of delivering view-dependent images to both eyes, and input/output interfaces for supporting data exchange necessary for rendering.

The invention supports both single-viewer and multi-viewer applications, improves field of view, stability, and realism of 3D visual effects, and enables reduced computational load without sacrificing perceptual quality. Applications include holographic video conferencing, glasses-free 3D media playback, holographic live broadcasting, immersive gaming, and other display scenarios.

Compared with the prior art, the present invention offers at least the following technical advantages.

By using real-time eye tracking to obtain six-degree-of-freedom eye coordinates and dynamically rearranging the viewpoint map based on a human-eye characteristic model, display-device parameters, and a light-field distribution model derived from the optical structure, the system adaptively adjusts subpixel offsets to keep the viewing zone centered on the viewer's gaze. This ensures stable 3D visualization even when the viewer's eyes move beyond the nominal viewing range, thereby expanding the effective viewing zone and significantly improving field of view, image clarity, and resolution-without increasing hardware cost. At constant computational load, the system enhances the holographic experience, or, for equivalent perceptual quality, reduces system resource requirements.

The viewing distance derived from real-time eye coordinates is used to compute an equivalent lens pitch, from which the system recalculates the reference viewing region and the number and distribution of viewpoints per eye. This allows precise control of subview generation in response to changes in viewing position, reducing computational overhead and avoiding image tearing artifacts.

The system adaptively adjusts the weights of rendering parameters—such as resolution, intrinsic/extrinsic parameters, contrast, and brightness-based on the spatial resolution of the optical structure and the temporal resolution of the eye-tracking system. This selectively lowers the fidelity of non-primary subviews, reduces inter-view crosstalk, and enhances overall 3D realism, while conserving rendering, transmission, and storage resources.

The method enables derivation of light-field screen design parameters based on light-field distribution models, ensuring that the optical structure approaches its physical limits of field of view, clarity, and image quality. This provides a robust foundation for designing next-generation naked-eye 3D display hardware.

The invention supports flexible viewpoint mapping by adjusting the correspondence of subviews and modifying the intrinsic and extrinsic parameters of virtual cameras in response to user movement. It accommodates both single-viewer and multi-viewer 3D rendering scenarios, making it suitable for applications such as holographic telephony, glasses-free 3D video playback, live holographic broadcasting, and immersive entertainment.

Real-time eye tracking can be augmented with an unscented Kalman filter to predict eye movement trajectories. Under conditions of low lighting or unreliable tracking, the system can fall back on empirical visual-response models to estimate eye coordinates with improved accuracy, thereby mitigating dizziness, ghosting, and related issues.

Depth-based Gaussian blur is applied to rendered objects using depth information, generating depth-of-field effects that enhance the appearance of distant objects and suppress crosstalk between adjacent views.

The above technical features may be combined in any mutually compatible manner. Additional features and advantages will be apparent from the detailed description and accompanying drawings, or will be realized through practice of the invention.

### BRIEF DESCRIPTION OF THE DRAWINGS

The drawings are provided for purposes of illustrating exemplary embodiments of the present invention and are not intended to limit the scope of the invention in any way. In the drawings, like reference numerals are used to identify like elements throughout the various views.

FIG. 1 is a flowchart illustrating a method for naked-eye 3D rendering based on light-field distribution, in accordance with an embodiment of the present invention.

FIG. 2 is a schematic diagram depicting the spatial light field in an exemplary embodiment.

FIG. 3 is a schematic diagram showing a viewpoint map in an exemplary embodiment.

FIG. 4 is a schematic diagram illustrating view-zone alignment in an exemplary embodiment.

FIG. 5 is a schematic diagram of a light-field image generated in an exemplary embodiment.

FIG. 6 is a block diagram of an apparatus for naked-eye 3D rendering based on light-field distribution, in accordance with an embodiment.

FIG. 7 is a block diagram of a naked-eye 3D display device, in accordance with an embodiment.

### DETAIL DESCRIPTION OF THE EMBODIMENTS

The following description sets forth preferred embodiments of the present invention with reference to the accompanying drawings, which form a part of this application. The drawings and embodiments are provided to illustrate the principles of the invention and should not be construed as limiting its scope in any way.

It should be understood that relational terms such as “first” and “second” are used herein solely for distinguishing one element or operation from another and do not imply any specific sequence or order unless otherwise indicated. As used herein, the terms “comprise,” “include,” and variations thereof are intended to denote non-exclusive inclusion. Accordingly, a method, process, article, or device that comprises a list of elements is not limited to those elements but may include other elements not expressly listed or inherently associated with such method, process, article, or device.

Unless otherwise specified, the phrase “comprising a . . . ” does not exclude the presence of additional, identical elements. Furthermore, the numbering of steps in the disclosed embodiments does not necessarily dictate execution order. Instead, the sequence may be determined by logical and functional relationships and should not be viewed as limiting.

The apparatuses, devices, and methods described herein may also be implemented in alternative configurations. For instance, the division of functional modules in certain apparatus embodiments is logical rather than physical, and the described functions may be combined, subdivided, or omitted altogether depending on implementation. Similarly, any communication or coupling between devices or components may be realized using direct or indirect interfaces, which may be electrical, mechanical, optical, or otherwise.

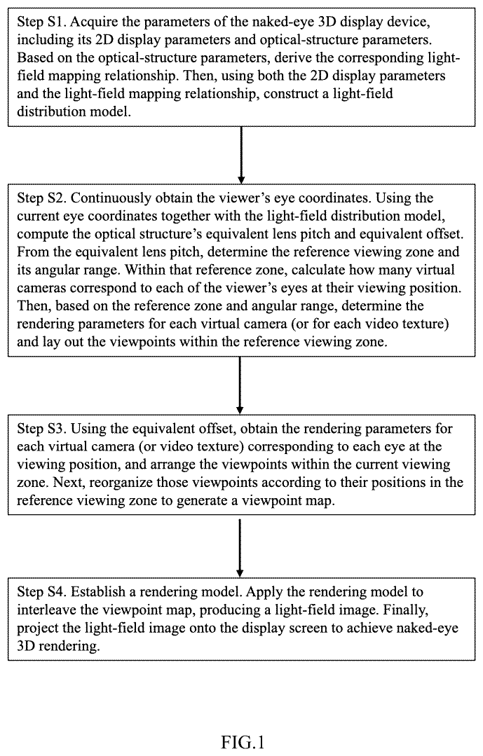

In one embodiment, a method for naked-eye 3D rendering based on light-field distribution is disclosed. As shown in FIG. 1, the method comprises the following steps:

S1. Acquiring parameters of the naked-eye 3D display device, including 2D display parameters and optical-structure parameters. A light-field mapping relationship is derived from the optical-structure parameters, and a light-field distribution model is constructed based on the 2D display parameters and the mapping relationship.

S2. Obtaining real-time eye coordinates of the viewer. Based on the eye coordinates and the light-field distribution model, an equivalent lens pitch and an equivalent offset for the optical structure are computed. A reference viewing region and its corresponding angular range are then determined from the equivalent lens pitch. The number of virtual cameras corresponding to each eye of each viewer is calculated, and rendering parameters for each virtual camera or video texture are derived. Viewpoints corresponding to these parameters are arranged within the reference viewing region.

S3. Based on the equivalent offset, updated rendering parameters corresponding to each eye of each viewer at the viewing position are determined. Viewpoints are arranged within the current viewing region and reordered based on the layout of the reference viewing region to generate a viewpoint map.

S4. A rendering model is established. The viewpoint map is interleaved according to this model to generate a light-field image, which is then projected onto the display screen to produce a naked-eye 3D rendering.

In step S1, the 2D display parameters may include screen size, aspect ratio, resolution, and pixel pitch. The optical-structure parameters may include the refractive index, fill spacing, lens focal length, viewing angle, spatial resolution, lens pitch, thickness, tilt angle, and other design parameters.

The naked-eye 3D display device typically includes a 2D display panel and an optical structure layered on top. The 2D panel comprises a periodic array of light-emitting units capable of emitting red, green, and blue light. The optical structure enables different angular views to be delivered simultaneously to the left and right eyes of a viewer, creating the perception of depth. Suitable optical structures include slit gratings, lenticular lenses, liquid crystal gratings, and spatial light modulators. Lenticular gratings are preferred in multi-viewer environments due to their wider field of view.

The light-field mapping relationship may be established through one or more of the following approaches: theoretical or numerical computation, Monte Carlo simulation, machine learning using neural networks, or calibration using standard light sources.

For example, geometric optics or empirical numerical models may be used to analytically derive light-ray deflection paths for periodic lens structures. Monte Carlo methods, such as those implemented in simulation platforms like Geant4, can simulate the physical interaction of light with a 3D model of the optical structure across visible wavelengths to generate a full-parameter light-field response.

In machine learning approaches, a neural network is trained using images of various 3D scenes captured from multiple eye positions. The network learns to map input eye coordinates to appropriate rendering parameters, effectively learning the light-field transformation induced by the optical structure.

Alternatively, empirical calibration can be performed using controlled light sources. By measuring refraction, dispersion, and intensity patterns at various angles through the optical structure, a mapping relationship can be directly inferred.

These techniques may also be combined—for instance, using simulation results during the design phase and empirical calibration after assembly—to account for manufacturing tolerances and ensure accurate rendering.

The light-field distribution model thus represents how the optical structure modifies the angular emission characteristics of light from the display panel into the viewing space, forming the basis for real-time 3D rendering.

It should be noted that, for ease of description, we define the following coordinate systems: the world coordinate system of the virtual space containing the target to be rendered is denoted W_{xyz}, the screen coordinate system of the 2D display panel, given by the panel's two-dimensional pixel coordinates, is denoted S_{xy}, the observation-space coordinate system describing the positions of the viewer's eyes and the naked-eye 3D display device is denoted Ob_{xyz}, and the eye-centric visual coordinate system is denoted V_{xyz}. The screen coordinate system S_{xy} follows the usual conventions used in rasterization, graphics pipelines, and display-system definitions. The observation-space system Ob_{xyz} has its origin at the geometric center of the display panel's light-emitting elements; its positive Z-axis extends outward normal to the panel in a right-handed sense. The visual coordinate system V_{xyz} for each eye has its origin at the eye's optical center; its positive Z-axis points straight ahead in a right-handed sense. We denote by Tob-v the transformation matrix from Ob_{xyz} to V_{xyz}, by T_{V-Ob} the inverse transformation, and so on for other coordinate-system mappings.

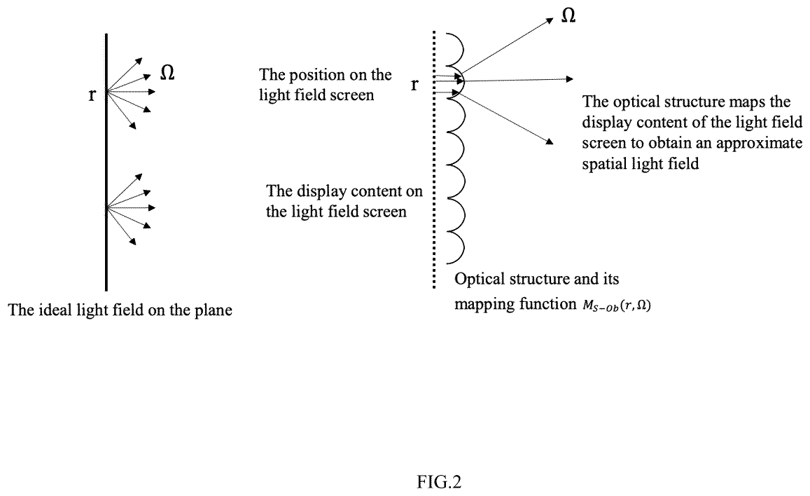

As shown in FIG. 2, a given light-emitting element at screen coordinate S(x, y) passes through the optical structure and emits from the structure's exit surface into observation space Ob(x′, y′, z′) over a range of angles. In particular, emission at angle α(θ,φ), over a range of angles. In particular, emission at angle α produces a view α(θ,φ) whose effective pixel consists of all emission points Ob₀(x′, y′, z′|α), Ob₁(x′, y′, z′|α), Ob₂(x′,y′,z′ α) that leave the structure α(θ,φ).

At each moment t, each viewer p's eye i is described by a six-degree-of-freedom coordinate Eₚ_{ᵢ}(xₚ_{ᵢ}, yₚ_{ᵢ}, zₚ_{ᵢ}, φₚ_{ᵢ}, θₚ_{ᵢ}, ψₚ_{ᵢ}, t); xₚ_{ᵢ} is the horizontal (left-right) position of eye i of viewer p relative to the display screen; yₚ_{ᵢ} is the vertical (up-down) position; zₚ_{ᵢ} is the distance along the screen-normal direction (in-out coordinate); φₚ_{ᵢ} is the yaw angle (rotation about the vertical z′-axis, corresponding to looking left or right); θₚ_{ᵢ} is the pitch angle (rotation about the horizontal y′-axis, corresponding to looking up or down); ψₚ_{ᵢ} is the roll angle (rotation about the x′-axis, corresponding to tilting the head sideways); and t denotes time.

In order to clarify the invention, we next describe the light field and its mapping through the optical structure. The general form of a light field may be expressed as:

$$E ( r , t ) = A ( r , t ) \hat{e} {e}^{i ( ω t - k \cdot r + ϕ )} .$$

Here, E(r, t) represents the general plane-wave expression of the light field, where r=(x, y, z) is the position vector, A(r, t) is the light-field amplitude; ê is the unit vector characterizing polarization direction, ω is the angular frequency, k is the wavevector, φ is the initial phase.

Assuming the initial light field before passing through the optical structure (i.e., influenced by the optical properties of the 2D display device) is expressed as:

$${E}_{0} ( r , t ) = {A}_{0} ( r ) {\hat{e}}_{0} ( r ) {e}^{i ( {ω}_{0} ( r ) t - {k}_{0} ( r ) \cdot r + {ϕ}_{0} ( r )} ,$$

then after passing through the optical structure the light field becomes:

$$E ( r , t ) = \int A ( r , Ω ) \hat{e} ( r , Ω ) {e}^{i ( ω ( r , Ω ) t - k ( r , Ω ) \cdot r + ϕ ( r , Ω ) )} d Ω ,$$

where Ω denotes the spatial angle and dΩ denotes integration over that angle

In matrix form, the initial light field is:

$${V}_{0} ( r ) = ( \begin{matrix}{A}_{0} ( r ) \\ {k}_{0} ( r ) \\ {ω}_{0} ( r ) \\ {ϕ}_{0} ( r ) \\ {\hat{e}}_{0} ( r )\end{matrix} ) ,$$

and the light field after the optical structure is:

$$V ( r , Ω ) = ( \begin{matrix}A ( r , Ω ) \\ k ( r , Ω ) \\ ω ( r , Ω ) \\ ϕ ( r , Ω ) \\ \hat{e} ( r , Ω )\end{matrix} ) ,$$

The mapping relationship between the initial light field and the light field after the optical structure is expressed in matrix form as:

$$V ( r , Ω ) = M ( r , Ω ) {V}_{0} ( r )$$

Here, M(r,Ω) denotes the light-field mapping relation corresponding to the optical structure.

$$M ( r , Ω ) = ( \begin{matrix}a ( r , Ω ) & 0 & 0 & 0 & 0 \\ 0 & R ( r , Ω ) & 0 & 0 & 0 \\ 0 & 0 & b ( r , Ω ) & 0 & 0 \\ 0 & 0 & 0 & c ( r , Ω ) & 0 \\ 0 & 0 & 0 & 0 & P ( r , Ω )\end{matrix} ) ,$$

$$A ( r , Ω ) = a ( r , Ω ) {A}_{0} ( r ) , k ( r , Ω ) = R ( r , Ω ) {k}_{0} ( r ) , ω ( r , Ω ) = b ( r , Ω ) {ω}_{0} ( r ) ,$$

$$ϕ ( r , Ω ) = c ( r , Ω ) {ϕ}_{0} ( r ) , \hat{e} ( r , Ω ) = P ( r , Ω ) {\hat{e}}_{0} ( r ) .$$

By integrating (i.e., summing) the light field after the optical structure over all spatial directions, the input light field in the observation space—i.e. the light-field distribution model—is obtained and expressed as:

$$E ( r , t ) = \int A ( r , Ω ) \hat{e} ( r , Ω ) {e}^{i ( ω ( r , Ω ) t - k ( r , Ω ) \cdot r + ϕ ( r , Ω ) )} d Ω = \int A ( r , Ω ) \hat{e} ( r , Ω ) {e}^{i ( ω ( r , Ω ) t - k ( r , Ω ) \cdot r + ϕ ( r , Ω ) )} sin ( θ ) d θ d ϕ$$

In discrete form, this is represented as:

$$E ( r , t ) = {\sum }_{i = 1}^{{N}_{θ}} {\sum }_{j = 1}^{{N}_{ϕ}} A ( r , {θ}_{i} , {ϕ}_{j} ) \hat{e} ( r , {θ}_{i} , {ϕ}_{j} ) {e}^{i ( ω ( r , {θ}_{i} , {ϕ}_{j} ) t - k ( r , {θ}_{i} , {ϕ}_{j} ) \cdot r + ϕ ( r , {θ}_{i} , {ϕ}_{j} ) )} sin ( {θ}_{i} ) Δ θ Δ ϕ ,$$

Where N_{θ} denotes the number of discrete sampling points of the polar angle θ, N_{φ} denotes the number of discrete sampling points of the azimuthal angle φ, Δθ is the polar-angle step size, and Δφ is the azimuthal-angle step size. Unless otherwise stated, we denote by I(α) the view that should be observed at position r, and by C the position of a virtual camera in the eye's visual coordinate system V_{xyz}.

It should be noted that by the above method one may represent both (a) the light field formed by rays propagating from the display's light-emitting elements into the observation space and (b) the light field formed by rays traced from the viewer's pupil back to those light-emitting elements; the corresponding matrices thus relate by convolution and deconvolution. We denote the mapping from the light-emitting elements in the screen coordinate system to the light field after the optical structure as M_{S-Ob}(r,Ω), and the mapping from the observation-space light field through the optical structure back to the screen-coordinate light-emitting elements as M_{Ob-s}(r,Ω). Because some optical structures can actively adjust their light-field mapping over time, M_{S-Ob}(r,Ω) may also be written as M_{S-Ob}(r,Ω,t), and M_{Ob-s}(r,Ω) as M_{Ob-s}(r,Ω,t).

Specifically, in step S2 the real-time acquisition of eye coordinates includes: using existing eye-tracking algorithms (for example, AI-based pupil-distance tracking or infrared pupil-recognition methods) to obtain the eye's planar coordinates and pupil orientation in real time, and obtaining the depth value by one of time-of-flight, structured-light, or multi-camera triangulation techniques—thereby yielding the viewer's six-degree-of-freedom eye coordinates Eₚ_{ᵢ}.

It is optional to use the eye-tracking device to establish empirical curves of visual response. Because these curves vary with device size and viewing distance, pre-measured visual-response curves reduce the computational load during real-time eye-tracking rendering. Under low-light or other special conditions, when the real-time eye-tracking position has large uncertainty or low confidence, the visual-response empirical curves are used in place of real-time tracking to obtain the eye coordinates.

The eye coordinate denotes the viewer's eye position in the observation space at a given viewing location and viewing direction toward the screen.

Further, obtaining the current equivalent lens pitch and equivalent offset of the optical structure from the current eye coordinates and the light-field distribution model, and deriving the current reference viewing region and viewing-angle range from the equivalent lens pitch, includes the following:

First, determine the current viewing distance from the eye coordinates, and compute the equivalent lens pitch for that distance using the light-field distribution model. Next, compute the equivalent offset from the eye's horizontal and vertical positions (in the camera coordinate system), the viewing distance, and the subpixel coordinates in the screen coordinate system. Finally, derive the reference viewing region and viewing-angle range from the equivalent lens pitch.

Specifically, the viewing distance is simply the distance from the eye to the display screen, as determined by the current eye coordinates.

The current equivalent lens pitch represents the finest detail the optical structure can resolve at the current viewing distance. For a lenticular (cylindrical-lens) grating, the equivalent lens pitch ΔA is computed by:

$$Δ A = {A}_{0} \cdot ( \frac{1}{H} - \frac{1}{{H}_{0}} ) \cdot \frac{W}{2 \cdot tan ( \frac{{}^{fov} {A}_{0}}{2} )} ,$$

where ΔA is the equivalent lens pitch and also defines the reference viewing region; A₀ is the original lens pitch measured in subpixel units (i.e., the original viewing-region period); H₀ is the preset optimal viewing distance for the optical structure; H is the current viewing distance; fov_{A}_{₀} is the viewing angle at the original viewing-region period; and W is the average lens width on the 2D display panel in millimetres.

Other optical structures yield analogous formulas for equivalent lens pitch or related parameters.

The equivalent offset at the current viewing distance is the horizontal shift of the viewing region and viewing-angle range caused by the viewer's lateral eye displacement.

Assuming the eye-tracking camera is mounted directly above the horizontal center of the light-field screen (i.e., display panel)—with its optical axis errors calibrated so that the camera's horizontal and vertical axes align perfectly with the screen's horizontal and vertical directions—the equivalent offset ΔX is given by:

$$Δ X = ( {x}_{cam} - 0.5 ) \cdot \frac{tan ( \frac{{}^{fov} cam}{2} )}{tan ( \frac{{}^{fov} {A}_{0}}{2} )} - ( {x}_{{S}_{xy}} - 0.5 ) \cdot Δ A \cdot \frac{{W}_{OC}}{W} + {y}_{cam} \cdot ( cam\_ratio \cdot \frac{tan ( \frac{{}^{fov} cam}{2} )}{tan ( \frac{{}^{fov} {A}_{0}}{2} )} \cdot tan ( {α}_{len} ) ,$$

Where ΔX is equivalent offset, x_{cam}, y_{cam} are the normalized (0-1) horizontal and vertical coordinates of the eye within the camera's image frame; fov_{cam} is the camera's horizontal field of view; cam_ratio is the camera's frame aspect ratio, xₛ_{_{xy}} is the normalized (0-1) horizontal coordinate in the screen coordinate system, W_{oc} is the display-screen width in millimetres; and αₗₑₙ is the design tilt angle of the lenticular elements on the screen.

The current reference viewing region is the region on the display screen—expressed as a range of subpixel coordinates in the screen coordinate system—where the viewer's eye center, at the current viewing distance and facing the screen, sees the optimal 3D effect. Other optical structures yield their own equivalent lens-pitch values and hence their own reference viewing regions.

The current viewing-angle range is the angular field of view the viewer experiences at the current viewing distance: it is the angular range fov_{A}_{₀} defined by the original viewing-region period A₀, scaled by the equivalent lens pitch for the current viewing distance. The full viewing-angle range that the system can support—accounting for sliding of the equivalent offset—defines the maximum angles over which a 3D effect is maintained.

Through the light-field mapping relations, one can map between the screen coordinate system and the observation-space coordinate system, thereby mapping the reference viewing region to the viewing-angle range.

Finally, determining the number of virtual cameras corresponding to each viewer's eye at the viewing position from the reference viewing region simply counts the number of viewpoints within that reference region—each viewpoint corresponding to one virtual camera—thus yielding the required number of virtual cameras.

It should be noted that, taking a lenticular grating as the optical structure by way of example, the deflection of light rays by the lenticular elements is represented by a linear relationship, ignoring aberrations, off-axis nonlinearity, dispersion, brightness variations, and other secondary effects. Each pixel of the display panel consists of multiple subpixels. Along the period of the lenticular grating, each subpixel refracts at the focal plane into a different direction and then, after passing through the optical structure, reaches the observation space. The subpixels are regarded as point light sources, and the optical structure only changes the emission direction of the sources at the focal plane. Therefore, based on the relative positions of the subpixels on the screen and the optical elements, the refracted direction of each subpixel is obtained periodically. Within the current reference viewing region, all subpixels refracted in a given direction together form the viewpoint corresponding to that direction in the reference region; hence, the viewpoint direction represents the viewer's viewing angle. Centered on the viewpoint directed toward the eye's center, additional viewpoints are added laterally at intervals of 0.8° to 1.6°, yielding the total number of viewpoints within the current reference region.

Furthermore, the rendering parameters for each virtual camera include its resolution and its intrinsic and extrinsic parameters, while the rendering parameters for each video texture include its texture resolution, and so on.

It should be explained that the virtual-camera resolution is typically derived from the spectral-splitting characteristics of the optical structure—for example, a lenticular grating inherits the display panel's native resolution—while the virtual-camera intrinsics and extrinsics are calculated from the viewpoint direction and the optimal viewing distance. In other words, the rendering parameters for both the virtual cameras and the video textures can be obtained by means known in the art.

Moreover, arranging the viewpoints within the current reference viewing region comprises the following steps:

Rasterizing each subview according to its associated virtual-camera rendering parameters or video-texture rendering parameters, where each subview corresponds to one viewpoint in the reference region-that is, one viewing angle of the eye.

Organizing all subviews for the current reference region together according to a chosen storage format, such as a quilt image, multi-view disparity encoding (for example, MV-HEVC), or a texture array. Each subview in the reference viewpoint map is assigned its own index. The same procedure is applied for each eye of each viewer within its own reference region.

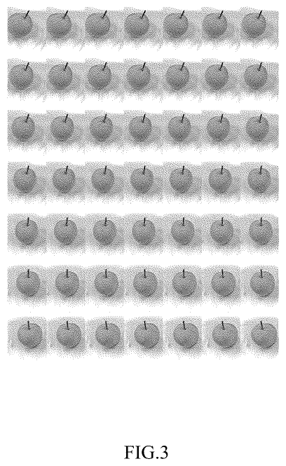

By way of example, and as shown in FIG. 3, a 7×7 array of subviews is used for viewpoint arrangement. From the top left to the bottom right, the subviews correspond to horizontal disparities ranging from −24° to +24° relative to the main viewing direction, with a one-degree step between adjacent subviews. The subviews are numbered 0 through 48 in row-major order, and all subviews share the same resolution.

Specifically, in step S3, arranging the viewpoints within the current viewing region based on the current equivalent offset includes the following steps:
sliding the current reference viewing region by the equivalent offset to obtain the current viewing region, and sliding the current viewing-angle range by the equivalent offset to obtain the current viewing-angle range. Aligning the center of the viewer's eye with the center of the current viewing region yields the current main viewing angle,
adjusting each virtual-camera's rendering parameters or video-texture rendering parameters based on the current main viewing angle, the viewing region, and the viewing-angle range, thereby determining the parameters for each virtual camera corresponding to each eye of each viewer at the viewing position,
rasterizing the target object's subviews according to these rendering parameters, and
organizing all subviews for the current viewing region together according to the chosen storage format—quilt image, multi-view disparity coding, or texture array—where each subview corresponds to one viewpoint in the current region and is assigned a unique index.

It should be noted that, because of the physical properties of the optical structure, the viewing region is arranged periodically; when the viewing distance remains unchanged, the reference viewing region also remains unchanged. When the viewer's eye moves laterally to the left relative to the display panel, the viewing region and the field of view shift laterally to the right. Therefore, given the equivalent offset and the current reference viewing region, one obtains the corresponding viewing region; likewise, given the equivalent offset and the current field-of-view range, one obtains the corresponding field of view. At a single viewing position, multiple subviews are captured at various angular deviations from the main viewpoint, i.e. at different viewing angles. According to real-time eye tracking, if the viewing distance changes, the reference viewing region changes accordingly, and thus the period of the lens elements in the screen coordinate system for the viewing region also changes—for example, the lens that was indexed m at one moment may correspond at the next moment to lenses indexed m−2, m−1, m+1 or m+2.

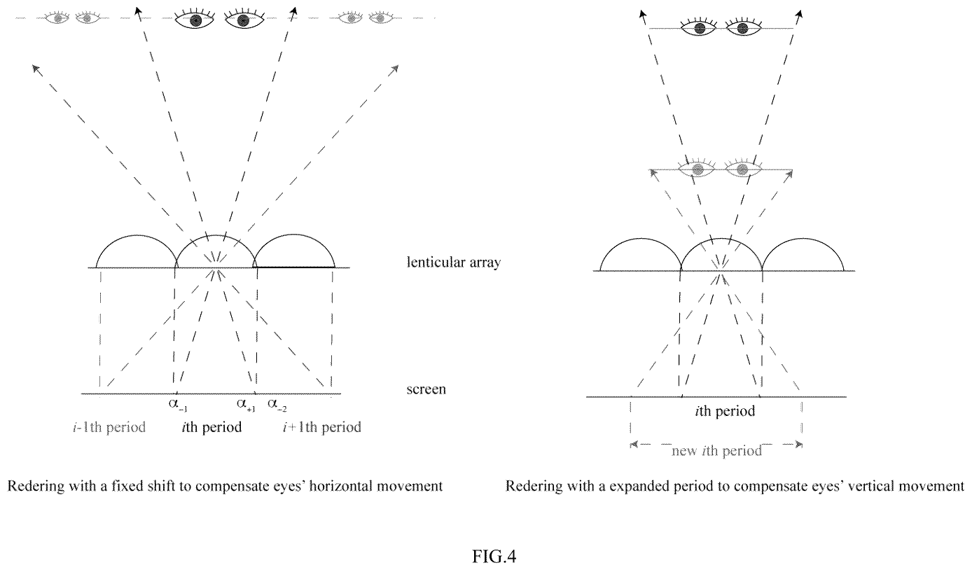

Because the number of viewpoints in the viewing region is determined by the viewing distance, failing to adjust that number when the viewing distance changes can cause visible tearing of the scene. As illustrated in FIG. 4, when real-time eye tracking indicates a change in viewing distance, the equivalent lens pitch is recomputed for the new distance, and the number of viewpoints—and hence the number of subviews in the viewpoint map—within the current viewing region is updated. If the eye moves closer than the nominal optimal distance, the equivalent lens pitch increases and more subviews are required; if the eye moves farther away, the equivalent lens pitch decreases and fewer subviews are needed.

Furthermore, reordering the viewpoints in the current viewing region based on the layout in the current reference viewing region to produce the viewpoint map comprises: identifying the overlapping and non-overlapping portions between the reference region and the current region; keeping the indices of subviews in the overlapping portion unchanged; mapping the subview indices in the non-overlapping portion of the current region to the corresponding non-overlapping portion of the reference region; and thereby reordering the viewpoints within the current region to form the new viewpoint map.

If, at the current instant, the viewing distance has not changed since the prior instant, then the prior viewing region serves as the current reference region, and the viewpoints are reordered based on the previous layout. For example, if at the previous moment the subview indices in the viewing region ranged from α−1 through α₁, and at the current moment they range from α−2 through α₂, then the overlapping portion covers α−2 through α₁ (whose indices remain unchanged) and the non-overlapping portion covers α₁ through α₂. Mapping indices α₁-α₂ to positions α-1-α-2 and reordering yields the new sequence α₁-α₂ followed by α−2-α₁.

As a concrete example, suppose the viewpoint map contains 21 subviews. At the previous moment the subview indices were −10 through +10; at the current moment they are −5 through +15. Then −5 through +10 remain in place, and indices 11-15 are mapped to positions −10 through −6, producing the reordered sequence 11-15 followed by −5-10.

In order to maintain good display quality, the center of the viewing region is aligned with the eye center. When the eye's tracked viewing angle moves beyond the nominal screen period covered by a given lens element, rays pass through an adjacent lens to reach the panel. For instance, a given effective pixel for the nominal region might originate from lens element m; when the eye moves beyond that region, the effective pixel may come from lens m−1, m−2, m+1 or m+2, depending on the optical mapping. According to the light-field mapping relation, each subview is mapped to specific pixels on the 2D panel, and shifting the viewing region essentially shifts those pixel coordinates. Because lens elements are approximately periodic and the tracked-eye updates occur rapidly with small offset each time, the overlapping portion remains large and most subviews stay unchanged; for the non-overlapping portion, pixels are simply reassigned from one grating cell to another. Since the grating cells are periodic, the shifted viewing region effectively uses the same pixels as the original region.

Understandably, the present invention obtains six-degree-of-freedom eye coordinates via real-time eye tracking and, based on a human-eye characteristic model, the parameters of the naked-eye 3D display device, and the light-field distribution model induced by the optical structure, rearranges the viewpoint map of the target to be rendered and improves the interleaving result. It takes into account, at every instant, each observer's each eye attributes in the light field and the full-parameter mapping relation through the optical structure, and adjusts the effective offset of corresponding subpixels on the screen so that the viewing region remains aligned with the center of the eye coordinates even when the eye moves. Therefore, when the eye goes beyond the normal viewing-angle range, the viewer can still see a clear 3D scene without sudden jumps. The viewing-zone range expands from the originally small region to a larger range determined by real-time eye tracking or by the optical performance of the screen and grating. This method significantly improves the field of view, clarity, and resolution of the naked-eye 3D device without increasing cost, and at equal computational load enhances the holographic experience, or, at similar holographic quality, greatly reduces computing-system requirements.

Understandably, the present invention computes the viewing distance from the eye coordinates obtained by real-time eye tracking, then derives the equivalent lens pitch based on that distance and recalculates the reference viewing region as well as the number and distribution of viewpoints within that region. Because changes in distance and in the screen-coordinate x and y positions of subpixels lead to variations in the equivalent lens pitch and equivalent offset, the viewpoints in the current viewpoint map are accordingly rearranged. For example, when the viewing distance is smaller or larger than the standard distance, the equivalent lens pitch increases or decreases, the number of viewpoints within the viewing region increases or decreases, and the number of interleaved viewpoints correspondingly increases or decreases, thereby rearranging more or fewer subviews in the viewpoint map. This precisely controls the number of subviews required for each observer's each eye, reduces resource consumption, and avoids problems such as 3D image tearing.

Specifically, in step S4, for a given viewing position the rendering model is expressed as:

$${I}_{total} ( {res}_{S} , t ) = {Swizzle}_{i = 0}^{k} I ( α , t ) ,$$

Where resₛ denotes the resolution of the interleaved light-field image and t denotes time;

$${Swizzle}_{i = 0}^{k}$$

denotes interleaving subviews indexed i=0, 1, 2, . . . , k; and I(α, t) denotes the viewpoint map at time t for the main viewing angle α, which consists of k+1 subviews indexed i=0, 1, 2, . . . , k.

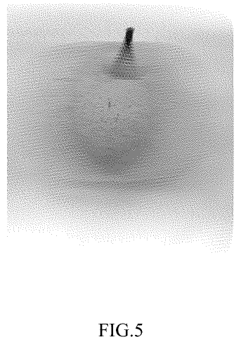

It should be noted that texture sampling—that is, interleaving—the viewpoint map yields the light-field image. In this process, subviews that deviate from the main angle α are interleaved with the same weight and resolution. Similarly, one can derive the rendering-model expression for each viewing position and interleave its corresponding viewpoint map to obtain the light-field image. By way of example, interleaving the 49 subviews of the viewpoint map shown in FIG. 3 produces the light-field image illustrated in FIG. 5.

Furthermore, the light-field image is projected onto the display screen to realize naked-eye 3D display. It should be explained that in the rasterization rendering method, rays from different viewpoint directions are refracted and focused onto the 2D display panel's screen coordinates via the lenticular grating near the optical axis. The mapping relation of ray directions within the grating period determines the intrinsic and extrinsic parameters of the multi-view virtual cameras used in rendering. When using video-texture rendering, multiple view-angle video streams have already been fused offline into a single texture file, which can be directly interleaved to yield the light-field image.

Moreover, the present invention can render directly from a disparity map—i.e., providing a 3D effect directly from the left and right views seen by the eye—or by interleaving the viewpoint map—i.e., using a virtual camera's view-dependent parallax generated in virtual space as the viewer moves to provide the 3D effect.

Specifically, the present invention can alter the correspondence of subviews within the viewing region after viewpoint shifts, and can also modify the intrinsic and extrinsic parameters of each subview's virtual camera, while considering both the viewpoint arrangement in the viewpoint map and the virtual-space position corresponding to each viewpoint provided to the user. In the extreme case, only a single viewpoint may be provided to the user (similar to binocular 2D), but the virtual camera's intrinsics and extrinsics change with the eye's movement so that the user perceives different occlusion relationships when moving—i.e., a true 3D effect is directly provided by the left-right view disparity seen by the eye. Therefore, the method and system of the present invention support both binocular naked-eye 3D rendering and simultaneous multi-observer naked-eye 3D rendering.

Another specific embodiment of the present invention further comprises the following steps:

Step S11. Construct, according to human-eye characteristics, an eye-characteristic model corresponding to the rendering parameters of each virtual camera or video texture. Perform a Fourier transform or Gaussian convolution on this eye-characteristic model. Based on the current eye coordinates, obtain the weight or convolution kernel for each rendering parameter of each virtual camera or video texture corresponding to each viewer's eye at its viewing position.

Step S12. Using the obtained weights or convolution kernels, update in Step S3 the rendering parameters of each virtual camera or video texture for each viewer's eye at its viewing position. Arrange the viewpoints within the current viewing region accordingly. Then, based on the arrangement of viewpoints in the current reference viewing region, reorder the viewpoints in the current viewing region to produce the new viewpoint map. Finally, interleave the viewpoint map using the rendering model to obtain the light-field image, and project this light-field image onto the display screen for naked-eye 3D rendering.

Specifically, in Step S11 the human-eye characteristics include the effects of retinal and cone-cell distributions on light-field reception. The eye-characteristic model may include, for example, a chromatic-aberration model and a visual-sensitivity model. The chromatic-aberration model represents color shifts within a given pupil viewing-angle range (for example, ±α degrees), and the visual-sensitivity model describes the relationship between human visual resolution and viewing angle.

It should be noted that for each rendering parameter of each virtual camera or video texture, a corresponding eye-characteristic model can be constructed. Each such model is expressed as a function curve relating the eye characteristic to that rendering parameter, thereby capturing their interdependence.

Furthermore, performing the Fourier transform or Gaussian convolution on the eye-characteristic model comprises, for each viewer, transforming the model within the viewer's six-degree-of-freedom eye coordinate system, treated as the origin of that viewer's eye-centric visual coordinate system. This produces the weight or convolution kernel for each rendering parameter of each virtual camera or video texture in that viewer's visual coordinate frame.

It should be noted that these weights or convolution kernels are vectors or vector functions describing the spatial distribution of the eye-characteristic model in the visual coordinate system. By decomposing an eye-characteristic model via Fourier transform or Gaussian convolution, the coefficients of its components become the weights or convolution kernels for that rendering parameter in each virtual camera or video texture; the coefficient of the largest component serves as the weight or convolution kernel for the main viewing angle. Applying this process to every rendering parameter yields a weight matrix or convolution-kernel matrix for all virtual-camera and video-texture parameters.

It is understood that, as needed, only selected rendering-parameter models may undergo Fourier transform or Gaussian convolution to derive the corresponding weights or kernels, while the weights of all other rendering parameters remain at a default value of one.

By way of example, in some embodiments the chromatic-aberration model is used to construct the spatial distribution of wavelength-dependent weights or convolution kernels in the visual coordinate system V_{xyz}, and the visual-sensitivity model is used to construct the spatial distribution of resolution weights or convolution kernels in the visual coordinate system V_{xyz}.

Further, obtaining the weight or convolution kernel for each rendering parameter of each virtual camera or video texture corresponding to each viewer's eye at its viewing position based on the current eye coordinates comprises transforming the visual coordinate system to the observation-space coordinate system according to the current eye coordinates. In this way, the weights or convolution kernels defined in the visual coordinate system become the weights or convolution kernels for each rendering parameter of each virtual camera or video texture corresponding to each viewer's eye in the observation-space coordinate system.

It should be noted that the weights or convolution kernels derived from the eye-characteristic model describe a spatial distribution in the absence of the light-field optical structure; therefore, they must be mapped into the observation-space domain after passage through the optical structure. Denote the weight or convolution-kernel function in the absence of the optical structure—expressed over the virtual-world, screen, or observation-space coordinate systems—as ψ_{W′/F′/V′}(r_{W′/F′/V′},Ω_{W′/F′/V′}); Since the mapping properties of observation space do not change with or without the optical structure, V′ equals V. Thus, after mapping through the optical structure, the relation from v′→W′/F′ and from v→W/FS or O—are determined by the light-field mapping relation M. Let \tilde{T}; ψ_{W′/F′/V′} to ψ_{W/F/V} mapping as [symbol] , then the post-structure weight or convolution kernel in observation-space coordinates is given by:

$${Ψ}_{W / F / V} ( {r}_{W / F / V} , {Ω}_{W / F / V} ) = \text{?} ( {Ψ}_{{W}^{′} / {F}^{′} / {V}^{′}} ( {r}_{W / F / V} , {Ω}_{W / F / V} ) = \text{?} ( {Ψ}_{{W}^{′} / {F}^{′} / {V}^{′}} ( \tilde{T} ( {r}_{{W}^{′} / {F}^{′} / {V}^{′}} , {Ω}_{{W}^{′} / {F}^{′} / {V}^{′}} ) ) )$$

By way of example, in some embodiments Gaussian convolution kernels are used. Taking the visual-sensitivity model as an example, a quantitative relationship is established between the Gaussian kernel and spatial frequency via the visual-sensitivity curve. A second quantitative relationship is then established between the root-mean-square error (RMSE) of the Gaussian-filtered image and the appropriate level of a multi-resolution texture map (Mipmap). These relationships may be expressed as:

$$σ ( {r}_{{W}^{′} / {F}^{′} / {V}^{′}} , {Ω}_{{W}^{′} / {F}^{′} / {V}^{′}} ) = \frac{d ( {r}_{{W}^{′} / {F}^{′} / {V}^{′}} - {r}_{o {W}^{′} / {F}^{′} / {V}^{′}} )}{e ( {Ω}_{{W}^{′} / {F}^{′} / {V}^{′}} )} \cdot \frac{1}{1.86 {f}_{c}} ,$$

where σ is the Gaussian-filtered image at the original central-view resolution, f_{c} spatial frequency, e(Ω_{W′/F′/V′}) is the retinal eccentricity, and d(r_{W′/F′/V′}−r_{0W′/F′/V′}) is the Euclidean distance between coordinates r_{W′/F′/V′} and r_{0W′/F′/V′}. In some embodiments, empirical measurements set RMSE threshold σ=0.4e^{0.705m}. Next, using the light-field mapping relation \tilde{M} for the optical structure, the convolution kernel in the observation-space coordinate system for the visual-sensitivity model is obtained as:

$$σ ( {r}_{W / F / V} , {Ω}_{W / F / V} ) = \frac{d ( {r}_{W / F / V} - {r}_{oW / F / V} )}{e ( {Ω}_{W / F / V} )} \cdot \frac{1}{1.86 {f}_{c}} ,$$

where,
r_{W/F/V},Ω_{W/F/V}=\tilde{T}(r_{W′/F′/V′},Ω_{W′/F′/V′}), is the kernel defined in the visual coordinate system. From this, the appropriate Mipmap level for different viewing positions relative to the eye's main viewing angle can be determined.

It should be noted that Mipmap consists of a series of progressively downsampled texture images designed to improve texture-mapping efficiency and quality. Each such image is referred to as a Mipmap level.

Specifically, in step S12 the process of updating each virtual camera's or video texture's rendering parameters for each viewer's eye based on the weights or convolution kernels, and then arranging the viewpoints within the current viewing region, comprises:

1. Applying the weights or convolution kernels to update the weights or kernels associated with every rendering parameter of each virtual camera or video texture for each eye, thereby updating all rendering parameters.

2. Rasterizing the updated rendering parameters of each virtual camera or video texture to generate the subviews of the target object to be rendered.

3. Organizing all subviews for the current viewing region into a chosen storage format—such as a quilt image, multi-view disparity encoding (e.g. MV-HEVC), or a texture array—where each subview corresponds to one viewpoint in the region and carries its own index.

Furthermore, following the method of step S3, the viewpoints in the current viewing region are reordered according to the layout in the current reference viewing region to produce the viewpoint map; and following the method of step S4, the viewpoint map is interleaved via the rendering model to generate the light-field image, which is then projected onto the display screen to achieve naked-eye 3D rendering.

For a given viewing position, the rendering model is expressed as:

$${I}_{total} ( {res}_{S} , t ) = {Swizzle}_{i = 0}^{k} I ( α , t ) = {Swizzle}_{i = 0}^{k} {γ}_{i} {Quilt}_{i} ( {λ}_{ij} , α , {res}_{{V}_{m}} , t ) ,$$

Where Quiltᵢ(λᵢⱼ,α,res_{V}_{ₘ},t) denotes the i-th subview of the viewpoint map at time t for the main viewing angle α; res_{V}_{ₘ} is the resolution of that subview; λᵢⱼ is the weight of the j-th rendering parameter of the i-th subview (j=0 . . . n, where n is the total number of rendering parameters per virtual camera or video texture); and γᵢ is the weight of the i-th subview.

In particular, λᵢⱼ can be interpreted as the probability-density distribution of each subview's viewing angle when eye-tracking position is accurate. To account for eye-tracking frame rate and spatial uncertainty, λᵢⱼ may be refined by combining unscented Kalman filtering of the tracked position, predicted tracking-frame values, and multi-camera triangulation, yielding a joint spatio-temporal probability-density distribution of the light field perceived by each eye. By modeling tracking-frame rate and predicting eye-position and velocity distributions, one computes the joint density distribution under the rendering model. Eye-motion states can be estimated using Kalman filtering with a control matrix, extended Kalman filtering, particle filtering, or unscented Kalman filtering; the unscented Kalman filter is particularly advantageous for nonlinear eye-movement dynamics and processing speed.

It should be noted that if no weight update is applied to a particular rendering parameter, its weight remains at one. In the formula above, no further constraints are imposed on the orthogonality between γᵢ and λᵢⱼ; any orthogonal-decomposition algorithms derived therefrom are also encompassed by this invention.

It can be understood that, based on the optical structure's spatial resolution and the eye-tracking system's temporal resolution, this invention may adjust the weights of virtual-camera rendering parameters (for example, lowering the resolution, intrinsics, extrinsics, contrast, or brightness of subviews for non-primary viewing angles) or apply weights directly to subviews in the viewpoint map (for example, reducing the weight of non-primary subviews). By fully leveraging the characteristics of every component of the naked-eye 3D system—including the optical structure—this approach reduces crosstalk between views and enhances visual realism. While ensuring high-quality naked-eye 3D display, it drastically cuts resource consumption in storing, transmitting, and rendering the viewpoint map, thereby saving bandwidth, and provides a solid basis for designing naked-eye 3D display optical structures and compute units. By combining real-time eye tracking with unscented Kalman filtering to predict eye-movement trajectories—and, under low-light or other challenging conditions, substituting empirical visual-response curves when tracking confidence is low—this method achieves more accurate eye coordinates and mitigates dizziness and ghosting issues.

By way of example, suppose that the eye-characteristic model is filtered and discretized to obtain the best discrete approximation of the viewpoint map I(α) at the observation position, given by: I(α)=ΣQuiltᵢ(λᵢⱼ,α,res_{V}_{ₘ}), When the eye-tracking prediction equals the true value α, I(α) is the true signal. The spectral distribution curve arising from the probability distribution I(α′|χ(α′) of the predicted eye-tracking position constitutes the power spectrum, and χ(α′) is the probability density function represents the eye-tracking uncertainty.

In some embodiments, only the main viewing angle is treated as the desired signal: any main-viewpoint α whose predicted eye-tracking position lies within a reliability threshold—assessed by the threshold and the eye-position probability distribution χ(Eₚ_{ᵢ})—is considered the true signal, while eccentric angles are treated as noise. In certain implementations, the main-viewpoint component is decomposed in the frequency domain alongside the visual-sensitivity curve model CT(f, e); the weights λᵢⱼ are derived from the probability-density decomposition χ(Eₚ_{ᵢ}). The desired signal is then defined as I(α|E_{pᵢ}=“true value”), and the noise signal as I(α|Eₚ_{ᵢ}“probability-density value”).

In further embodiments, the weights computed by the above method, together with system configuration parameters, determine a rendering threshold for crosstalk reduction, or dynamically adjust that threshold according to the user device's compute capability or configuration. In multi-viewer scenarios, each viewer's eye coordinates Eₚ_{ᵢ} determine the primary views that must be rendered; to produce a 3D effect, at least one primary view per eye is required. Traditional naked-eye 3D rendering interleaves all multi-viewpoint images, causing inter-view crosstalk and high rendering load. By using the light-field mapping relation and the calculated weights or convolution kernels, the present invention can more effectively select the spacing between virtual cameras or disable rendering of eccentric views when reducing crosstalk or compute demands. For example, if the forward visual-sensitivity curve CT(f, e) sets a threshold θ_vis for rendering configuration, and the device's compute power or configuration sets per-view resolution thresholds R_i or a total viewpoint-map resolution threshold R_tot, then the above visual-curve filtering process yields the appropriate total number of views and per-view filter thresholds for I(α)=ΣQuiltᵢ(λᵢⱼ,α,res_{V}_{ₘ}). The levels and thresholds derived from the visual-sensitivity curve determine which views are disabled. In the extreme case, only the main viewing angle—estimated by unscented Kalman filtering of the eye-tracking data—is rendered.

In some embodiments, the joint probability-density magnitude derived from the visual-sensitivity model and the eye-tracking uncertainty is adjusted by thresholds to enable reliable view selection under constraints of view redundancy, rendering efficiency, compute capacity, and frame rate. Raising the joint probability density for non-primary viewing angles increases the number of subviews needed to maintain the 3D effect; lowering that density allows more non-primary views to be discarded.

In multi-viewer scenarios, crosstalk is quantified by the number of address conflicts among subpixels mapped for different views. When crosstalk exceeds acceptable limits, the system may, according to configuration settings, reduce the number of rendered views per eye for each viewer. If crosstalk still exceeds a higher threshold, only monocular rendering is performed, and each viewer sees a 2D image. By using the joint probability-density magnitude derived from visual-sensitivity and eye-tracking models, together with a probability-modulation scheme, the system can smoothly transition each eye's display mode—from multi-view 3D to binocular 3D, and ultimately to 2D—while maximizing crosstalk tolerance.

Optionally, to compensate for the latency of the eye-tracking system, which typically ranges from 20 ms to 80 ms, a predictive eye-tracking algorithm is trained using the device's fixed system delay and recorded eye-movement data from naked-eye 3D viewing sessions. During rendering, this predictor is used to estimate the zero-latency eye position.

When the eye moves vertically, the joint probability density immediately determines a new subpixel layout, enabling seamless switching between portrait and landscape orientations. The parameters defined earlier—viewing region, viewpoints, equivalent lens pitch, equivalent offset, etc.—apply equally to one-dimensional gratings (periodic only in the horizontal direction, producing parallax in one axis) and two-dimensional gratings (periodic in both axes, producing full-stereo parallax). In the two-dimensional case, the notation S₁, S₂, . . . becomes S(x,y), and the range S₋₁ . . . S₁ refers to the set of subpixels corresponding to the normal viewing region of a single grating cell. After offsetting, the overlapping portion of new and old viewing regions is the intersection of their subpixel sets, and the non-overlapping portions are the respective set differences. Viewpoints α₁ . . . α₂ generalize to α(θ, φ), representing the solid angle between an eye-to-screen ray and the screen plane.

In some embodiments, to enhance the main-viewpoint effect, the rendering model applies additional weighting for the central view as follows:

$${I}_{total} ( {res}_{S} , t ) = {Swizzle}_{i = 0}^{k} I ( α , t ) = {Swizzle}_{i = 0}^{k} {\sum }_{β} {γ}_{i} {Quilt}_{i} ( {λ}_{ij} , α , {res}_{{V}_{m}} , t )$$

where β indexes non-primary viewing angles, and

$${\sum }_{β}$$

indicates that subviews for those angles are added onto the primary subview.

In certain implementations, the brightness weight of views at large angular offsets is boosted based on the eye-tracking yaw angle (which corresponds to horizontal parallax), compensating for the brightness falloff of the lenses off their optical axis. In other words, views deviating more from the lens's central axis receive increased output brightness to offset lens-caused dimming.

In some embodiments, a centrally depressed (concave) spatial-domain filter derived from the human-eye characteristic model is applied to the light field to reduce off-axis imaging distortion.

In some embodiments, the viewpoint map is filtered to adjust the rendering-model weights so that the virtual-camera array achieves maximum gain in a specific direction. Examples of such filters include parametric multi-channel Wiener filters, post-Wiener filters, and optimal log-spectrum amplitude post-filters.

In certain embodiments, depth information is used to apply a depth-based Gaussian blur to the target object. This may involve simulating a denser set of viewpoints via lateral Gaussian blurring, and reducing resolution in the distance dimension with a two-dimensional Gaussian convolution kernel—avoiding one-dimensional blur and thereby improving the 3D display effect.

It is understood that lowering the density of rendered viewpoints can reduce computational and transmission overhead, but may cause distant points to break up into multiple artifacts, degrading the 3D effect at range. The present invention uses the rendered depth map to apply depth-based Gaussian blur—imposing a depth-of-field effect on objects away from the focal plane—to compensate the viewer's perception of distant objects while also reducing crosstalk.

In some embodiments, the depth-of-field boundary of the primary rendering target serves as a criterion for reducing the number of active virtual cameras, thereby mitigating crosstalk and enlarging the clear depth-of-field region around the main object. For example, whereas the rendering engine might normally employ N virtual cameras to produce N viewpoint maps, the system can instead use only M cameras (where 2≤M<N) for selected targets. This approach concentrates the same parallax information into fewer subviews—weakening crosstalk—while still delivering the necessary binocular parallax by increasing the precision of the eye-tracking system.

It is appreciated that conventional methods, which arrange every subview across many virtual-camera views, suffer from information redundancy, high processing cost, limited depth of field, and low utilization of the display's field of view. The present invention precisely controls, for each viewer's each eye, both the number of required subviews and their individual resolutions—saving computational effort, improving hardware and software resource usage, reducing crosstalk, and expanding the effective viewing region. The method supports both single-viewpoint 3D rendering—offering a 3D experience to a single viewer in motion—and multi-viewpoint rendering for multiple viewers moving independently. Consequently, the technology is applicable to holographic telephony, naked-eye 3D video playback, naked-eye 3D gaming, and similar applications.

Another embodiment of the present invention, taking a lenticular (cylindrical-lens) grating as an example, discloses a parameter-design method for the optical structure of a naked-eye 3D display device that implements the light-field-distribution-based naked-eye 3D rendering method. The method comprises:

Step S21. Based on the size of the light-field screen, the resolution of the 2D display panel, and the intended application scenario, determine the appropriate viewing distance. From that viewing distance and the human interpupillary distance, calculate the binocular angular span α₀ (in degrees) when both eyes are directed at the center of the light-field screen.

Step S22. According to manufacturing capabilities and empirical estimates, determine the spatial-resolution angular redundancy α₁ (in degrees).

Step S23. Based on the target cost of the naked-eye 3D display device, the total system latency of the hardware and software solution, an empirical function of human-eye movement speed, and the viewing distance, compute the time-resolution redundancy angle α₂ (in degrees) introduced by eye-tracking delay. From these values, derive the design angular pitch of the light-field screen's grating as

$$2 * ( \frac{{α}_{0}}{2} + \frac{{α}_{1}}{4} + {α}_{2} )$$

degrees.

Optionally, for large light-field screens used in multi-viewer scenarios where crosstalk avoidance is more critical, include an additional redundancy angle α₃ (in degrees). The grating's design angular pitch then becomes

$$2 * ( \frac{{α}_{0}}{2} + \frac{{α}_{1}}{4} + {α}_{2} ) + {α}_{3}$$

degrees.

It should be noted that the term “light-field screen” refers to the naked-eye 3D display device's screen as a whole, comprising the 2D display panel and the optical structure.

By way of example, consider designing a 15.6-inch desktop monitor intended to deliver multi-viewpoint stereoscopic display in a 16:9 landscape format, providing users with a high-quality 3D visual experience without glasses. Under a fixed cost budget, a 4K-resolution LCD panel with a conventional RGB subpixel arrangement is selected. Empirical estimates of manufacturing tolerances at this resolution yield a per-subpixel spatial-resolution redundancy angle α₁ of 4°. The user's interpupillary-distance angular span α₀ at the intended viewing distance is approximately 7.0°, and the time-resolution redundancy angle α₂ is set to 5°. Therefore, the display must support a horizontal field of view of

$$2 * ( \frac{7}{2} + \frac{4}{4} + 5 ) = 19.$$

Thus, this parameter-design method—grounded in the light-field-distribution-based rendering approach—yields the necessary design specifications for the naked-eye 3D display's light-field screen. By leveraging dynamic light-field mapping relations, it ensures that a given optical structure reaches the physical limits of viewing angle, image clarity, and imaging quality. This provides a foundation for designing naked-eye 3D displays that, at lower cost, achieve wider fields of view, higher clarity, greater depth of field, compatibility with both portrait and landscape orientations, and support for multiple simultaneous viewers—thereby overcoming the conventional trade-offs among resolution, depth of field, and field of view.

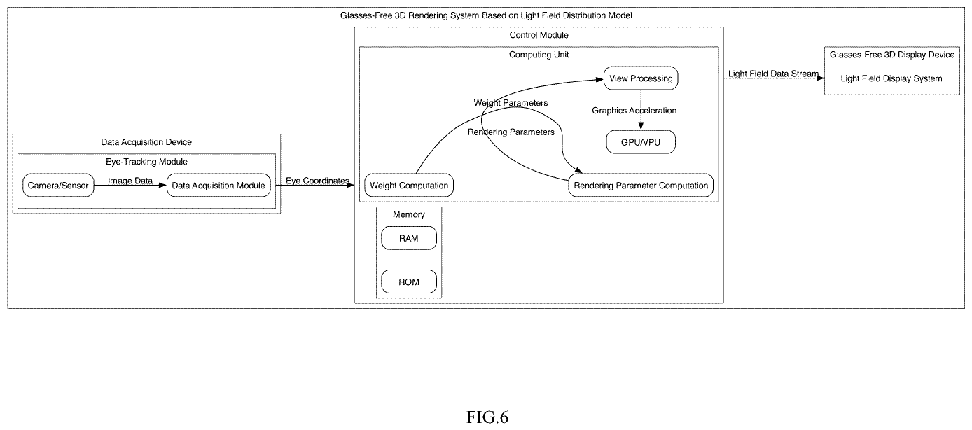

Another specific embodiment of the present invention discloses a naked-eye 3D rendering apparatus based on a light-field distribution model. As shown in FIG. 6, the apparatus comprises:
Data acquisition equipment, configured to obtain the parameters of the naked-eye 3D display device and real-time eye coordinates, and to send them to the control module;
Control module, configured to construct, from the device parameters, a light-field distribution model, a human-eye characteristic model, and a rendering model, to generate a light-field image based on the current eye coordinates, and to send the light-field image to the naked-eye 3D display device;
Naked-eye 3D display device, configured to present the received light-field image as a naked-eye 3D (holographic) display.

In detail, the data acquisition equipment includes one or more cameras or sensors, an eye-tracking module, and a data-acquisition module. The cameras or sensors capture facial images in real time and forward them to the data-acquisition module. The eye-tracking module measures eye-movement parameters—such as pupil diameter, gaze point, and gaze direction—in real time and forwards these to the data-acquisition module. The data-acquisition module computes the viewer's six-degree-of-freedom eye coordinates (the “eye-tracking values”) from the facial images and eye-movement data and transmits these to the control module; it also acquires the 2D display parameters and optical-structure parameters of the naked-eye 3D device and sends them to the control module.

The control module comprises a memory and a compute unit. The memory (ROM and RAM) stores relevant parameters, images, textures, and other data. The compute unit includes a rendering-parameter computation module and a view-processing module (and in a preferred configuration also a weight-computation module). The compute unit may be implemented using a GPU, VPU, or similar hardware accelerator.

The rendering-parameter computation module performs the following operations:
From the optical-structure parameters, derive the corresponding light-field mapping relation;
From the 2D display parameters and that mapping relation, build the light-field distribution model;
From the current eye coordinates and the light-field distribution model, compute the optical structure's current equivalent lens pitch and equivalent offset;
From the equivalent lens pitch, determine the current reference viewing region and its angular range;
From the reference region, compute how many virtual cameras correspond to each eye at its viewing position;
From the reference region and angular range, derive the rendering parameters (or video-texture parameters) for each virtual camera and arrange the viewpoints in the reference region;
From the equivalent offset, adjust and arrange the viewpoints in the current viewing region;
Reorder the viewpoints in the current viewing region according to the layout in the reference region to produce the viewpoint map; and
Transmit the viewpoint map (and, in some configurations, the light-field distribution model) to the weight-computation module.

The weight-computation module performs the following:
From the human-eye characteristic model (e.g. chromatic-aberration and visual-sensitivity models), compute spatial weights or convolution kernels via Fourier transform or Gaussian convolution;
Map those weights or kernels into the observation-space coordinate system according to the current eye coordinates;
Update each virtual camera's or video texture's rendering parameters using the computed weights or kernels and re-arrange the viewpoints in the current viewing region;
Reorder the viewpoints to produce an updated viewpoint map; and
Send the updated viewpoint map to the view-processing module.

The view-processing module constructs the final rendering model, interleaves the viewpoint map to generate the light-field image, and projects that image onto the display screen to achieve naked-eye 3D rendering.

This apparatus, implementing the light-field-distribution-based rendering method, supports both binocular-only 3D—providing a 3D effect to a single viewer in motion—and multi-observer 3D, simultaneously delivering independent 3D viewing experiences to multiple viewers. It is therefore suitable for applications such as holographic teleconferencing, naked-eye 3D video playback, holographic live broadcasts, and holographic entertainment.

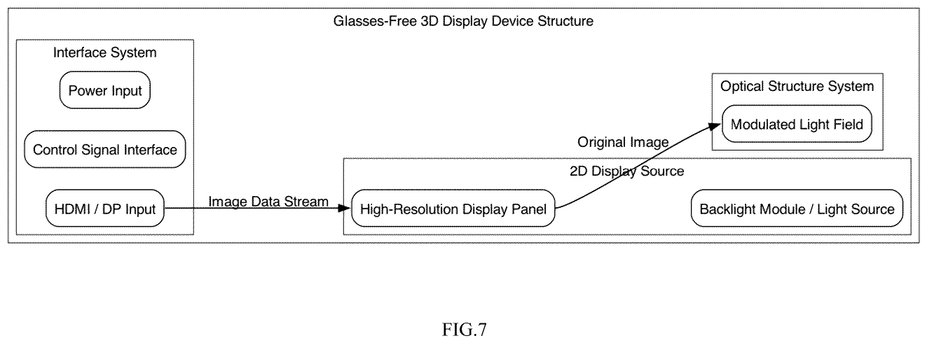

Another specific embodiment of the present invention discloses a naked-eye 3D display device. As shown in FIG. 7, the naked-eye 3D display device employs the light-field-distribution-based naked-eye 3D rendering method and comprises:
A 2D display device or light source, configured to provide 2D images;
An optical structure, configured to deliver different-angle views simultaneously to the viewer's left and right eyes, thereby realizing naked-eye 3D or holographic display;
Input/output interfaces, configured to transmit the data required for naked-eye 3D or holographic display.

In particular, the 2D display device consists of periodically arranged light-emitting units and pixels capable of displaying red, green, and blue. Preferably, the 2D display device is an LCD panel or an OLED panel.

In particular, the optical structure may be a slit grating, a lenticular grating, an adjustable liquid-crystal grating, or a spatial light modulator. Preferably, when providing 3D display to multiple viewers simultaneously (i.e., supporting multiple observation positions), a lenticular grating is used to achieve a larger field of view.

In particular, the input/output interfaces include USB, Mini HDMI, and HDMI ports.

It will be appreciated that this naked-eye 3D display device, by implementing the light-field-distribution-based rendering method, supports both binocular-only 3D for a single moving viewer and simultaneous multi-viewer 3D, and is therefore suitable for holographic teleconferencing, naked-eye 3D video playback, holographic live broadcasting, holographic entertainment, and similar applications.

Another specific embodiment of the present invention discloses an electronic apparatus for implementing the above embodiments. The electronic apparatus comprises:

A memory, for storing computer programs;

A processor, for executing the computer programs to perform the light-field-distribution-based naked-eye 3D rendering method described above.

It should be noted that the electronic apparatus may take the form of any digital computer—such as a desktop PC, workstation, or server—or any mobile device, such as a mobile phone or wearable device. The processor includes a compute unit, an input unit, an output unit, and a communication unit. The compute unit may include general-purpose and/or special-purpose processing components—such as a CPU, GPU, dedicated AI chips, machine-learning accelerator units, DSPs, controllers, or microcontrollers—that execute the stored programs. The input unit may include a keyboard and mouse; the output unit may include various displays and speakers; the communication unit may include a network card, modem, or wireless transceiver, enabling the apparatus to exchange information and data with other devices via computer and/or telecommunication networks.

Another specific embodiment of the present invention provides a computer program product, which comprises a computer program stored on a readable storage medium. When executed by the processor, this program causes the computer to perform the light-field-distribution-based naked-eye 3D rendering method described above.

Another specific embodiment of the present invention discloses a computer-readable storage medium that stores a computer program for executing the above-described light-field-distribution-based naked-eye 3D rendering method. The readable storage medium may be a volatile memory or a non-volatile memory.

Compared with the prior art, the light-field-distribution-based naked-eye 3D rendering method, apparatus, and display device provided by the present invention confer the following advantages:

By performing real-time eye-tracking to obtain six-degree-of-freedom eye coordinates and, based on a human-eye characteristic model, the naked-eye 3D display device parameters, and the optical-structure-induced light-field distribution model, rearranging the viewpoint map of the target to be rendered, this method improves the interleaving outcome. It accounts for each observer's individual eye attributes in the light field and the full-parameter mapping through the optical structure, and adjusts the effective offset of the corresponding subpixels on the screen so that the viewing region remains centered on the eye coordinates even when the eye moves. As a result, when the eye moves beyond the normal viewing-angle range, the viewer still sees a clear 3D scene without sudden jumps. The effective viewing zone expands from its original smaller region to a larger range determined by real-time eye-tracking or by the optical performance of the screen and grating. This method significantly increases the field of view, clarity, and resolution of the naked-eye 3D device at no extra cost, and under the same computational load enhances the holographic experience-or, for a similar holographic quality, greatly reduces system computing requirements.

The invention derives the viewing distance from the real-time eye coordinates, computes the equivalent lens pitch for that distance, and then recalculates the reference viewing region and the number and distribution of viewpoints within it. For example, when the viewing distance is smaller or larger than a standard distance, the equivalent lens pitch increases or decreases, and the number of viewpoints in the viewing region correspondingly increases or decreases, thus rearranging more or fewer subviews in the viewpoint map. This precisely controls the number of subviews needed for each eye of each observer, reducing resource consumption and avoiding tearing artifacts in the 3D image.

Based on the optical structure's spatial resolution and the eye-tracking system's temporal resolution, the invention adjusts the weights of the rendering parameters for each virtual camera used to generate each subview-lowering the resolution, intrinsics, extrinsics, contrast, brightness, etc., of subviews for non-primary viewing angles. This reduces crosstalk between views, enhances the realism of the 3D visual effect, and, while ensuring high-quality naked-eye 3D display, dramatically lowers the resource consumption associated with storing, transmitting, and rendering the viewpoint map, thereby saving bandwidth.

The method yields the design specifications for the naked-eye 3D display's light-field screen. By leveraging dynamic light-field mapping relations, it ensures that a given optical structure attains the physical limits of viewing angle, image clarity, and imaging quality. This provides a solid foundation for designing the optical structure of naked-eye 3D displays.

The invention can modify the correspondence of subviews within the viewing region after the observer moves, and can change the intrinsics and extrinsics of each subview's virtual camera, while taking into account both the interleaving method for the viewpoint map and the virtual-space positions corresponding to each viewing position. Thus, the method and system support both binocular-only naked-eye 3D rendering for a single viewer in motion and multi-observer naked-eye 3D rendering simultaneously for multiple viewers in motion. It is therefore applicable to holographic teleconferencing, naked-eye 3D video playback, holographic live streaming, holographic entertainment, and similar scenarios.

By combining real-time eye-tracking with an unscented Kalman filter to predict eye-movement trajectories—and, under low-light or other challenging conditions, using empirical visual-response curves in place of real-time tracking to estimate eye coordinates—the invention brings the tracked coordinates closer to true values, thereby mitigating dizziness and ghosting.

Using the rendered depth map, the invention applies depth-based Gaussian blur to the target object, imposing a depth-of-field effect on objects away from the focal plane. This compensates for the perception of distant objects and further reduces crosstalk.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuit.

When the functions disclosed herein are implemented in the form of software functional circuits and sold or used as independent products, they can be stored in a processor executable non-volatile computer-readable storage medium. Particular technical solutions disclosed herein (in whole or in part) or aspects that contributes to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training samples to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A naked-eye 3D rendering method based on light-field distribution, comprising:
acquiring parameters of a naked-eye 3D display device, the parameters comprising 2D display parameters and optical-structure parameters of the naked-eye 3D display device;
deriving a light-field mapping relation from the optical-structure parameters;
constructing a light-field distribution model from the 2D display parameters and the light-field mapping relation;
obtaining, in real time, eye coordinates of a viewer;
computing, based on the eye coordinates and the light-field distribution model, an equivalent lens pitch and an equivalent offset of an optical structure of the naked-eye 3D display device;
determining, based on the equivalent lens pitch, a reference viewing region and an angular range associated with the reference viewing region;
determining, within the angular range, a number of virtual cameras corresponding to each eye of the viewer;
determining, within the reference viewing region and the angular range, rendering parameters associated with the virtual cameras or video textures;
arranging viewpoints corresponding to the rendering parameters within the reference viewing region;
determining, based on the equivalent offset, updated rendering parameters corresponding to each eye of the viewer at a viewing position, and arranging viewpoints within a current viewing region according to the updated rendering parameters;
reordering the viewpoints in the current viewing region based on a layout of the reference viewing region to generate a viewpoint map;
constructing a rendering model and generating a light-field image by interleaving the viewpoint map according to the rendering model; and
projecting the light-field image onto a display screen to provide naked-eye 3D rendering.

2. The method of claim 1, wherein the determining the updated render parameters comprises:
constructing, based on human-eye characteristics, a human-eye characteristic model corresponding to the rendering parameters associated with the virtual cameras or video textures;
performing a Fourier transform or Gaussian convolution on the human-eye characteristic model;
obtaining, based on the eye coordinates, weights or convolution kernels corresponding to the rendering parameters of the virtual cameras or video textures for each eye of the viewer at the viewing position; and
applying the obtained weights or convolution kernels to determine the updated rendering parameters of the virtual cameras or video textures.

3. The method of claim 1, wherein the computing the equivalent lens pitch and the equivalent offset of the optical structure of the naked-eye 3D display device comprises:
determining a current viewing distance based on the eye coordinates of the viewer;
obtaining the equivalent lens pitch from the current viewing distance and the light-field distribution model;
computing the equivalent offset based on horizontal and vertical coordinates of the viewer's eye in a camera coordinate system, the current viewing distance, and sub-pixel coordinates in a screen coordinate system; and
deriving the reference viewing region and the angular range associated with the reference viewing region from the equivalent lens pitch;
wherein the determining the number of virtual cameras corresponding to each eye of the viewer comprises counting viewpoints within the reference viewing region, each viewpoint corresponding to a respective virtual camera.

4. The method of claim 1, wherein the determining the updated rendering parameters corresponding to each eye of the viewer at the viewing position and arranging viewpoints within a current viewing region according to the updated rendering parameters comprises:
sliding the reference viewing region by the equivalent offset to obtain the current viewing region;
sliding the angular range associated with the reference viewing region by the equivalent offset to obtain a current angular range;
aligning a center point of the viewer's eye with a center point of the current viewing region to determine a current primary viewpoint;
adjusting the rendering parameters of each virtual camera or video texture corresponding to each eye of the viewer based on the current primary viewpoint, the current viewing region, and the current angular range;
rasterizing subviews of a 3D object based on the adjusted rendering parameters; and
organizing the subviews corresponding to the current viewing region according to a storage format, wherein the storage format comprises one or more of quilt images, multi-view disparity coding, or texture arrays, and each of the subviews corresponds to a viewpoint within the current viewing region and is assigned a respective index.

5. The method of claim 1, wherein the reordering the viewpoints in the current viewing region based on the layout of the reference viewing region to generate a viewpoint map comprises:
identifying an overlapping region and non-overlapping regions between the reference viewing region and the current viewing region;
maintaining subview indices corresponding to the overlapping region unchanged;
mapping subview indices corresponding to the non-overlapping region of the current viewing region to corresponding positions in the non-overlapping region of the reference viewing region; and
reordering the viewpoints in the current viewing region based on the mapped and unchanged subview indices to generate the viewpoint map.

6. The method of claim 2, wherein the obtaining, based on the eye coordinates of the viewer, the weights or the convolution kernels corresponding to the rendering parameters of the virtual cameras or video textures for each eye of the viewer at the viewing position comprises:
transforming the eye coordinates from a visual coordinate system to an observation-space coordinate system; and
converting weights or convolution kernels associated with the rendering parameters of the virtual cameras or video textures from the visual coordinate system into the weights or the convolution kernels corresponding to each eye of the viewer at the viewing position in the observation-space coordinate system.

7. The method of claim 2, wherein, for a given viewing position, the rendering model is configured as follows:
when a main-viewpoint effect is not enhanced, the rendering model is expressed as:
$${I}_{total} ( {res}_{S} , t ) = {Swizzle}_{i = 0}^{k} I ( α , t ) = {Swizzle}_{i = 0}^{k} {γ}_{i} {Quilt}_{i} ( {λ}_{ij} , α , {res}_{{V}_{m}} , t )$$
where Quiltᵢ(λᵢⱼ,α,res_{V}_{ₘ},t) denotes an iₜₕ subview in the viewpoint map corresponding to a main viewpoint α at time t, res_{V}_{ₘ} denotes a resolution of the iₜₕ subview; λᵢⱼ denotes a weight of the jₜₕ rendering parameter of the iₜₕ subview (j=0, . . . ,n, where n is a total number of the rendering parameters of the virtual camera or video texture; and γᵢ denotes a weight of the iₜₕ subview; and
when a main-viewpoint effect is enhanced, the rendering model is expressed as:
$${I}_{total} ( {res}_{S} , t ) = {Swizzle}_{i = 0}^{k} I ( α , t ) = {Swizzle}_{i = 0}^{k} {{\sum }_{β}}_{} {γ}_{i} {Quilt}_{i} ( {λ}_{ij} , α , {res}_{{V}_{m}} , t )$$
where β denotes a viewpoint corresponding to a non-main-viewpoint subview, and
$${\sum }_{β}$$
represents a superposition of the subview corresponding to viewpoint β onto the subview corresponding to the main viewpoint.

8. The method of claim 1, further comprising a step of designing parameters for the optical structure of the naked-eye 3D display device, the step comprising:
determining a viewing distance based on a size of a light-field screen of the naked-eye 3D display device, a resolution of a 2D display panel of the naked-eye 3D display device, and an intended application scenario;
calculating a binocular visual angle α₀, in degrees, based on the determined viewing distance and a human interpupillary distance, wherein α₀ represents a visual angle when a viewer is centered relative to the light-field screen;
determining a spatial-resolution visual angle α₁, in degrees, based on manufacturing process capabilities and empirical estimates;
calculating a time-resolution redundancy visual angle α₂, in degrees, based on a target cost of the naked-eye 3D display device, a total hardware and software latency, an empirical model of human-eye movement speed, and the viewing distance; and
determining a design angular pitch of a raster of the light-field screen based on a sum of the calculated angles, wherein the design angular pitch is given by, in degrees:
$$2 * ( \frac{{α}_{0}}{2} + \frac{{α}_{1}}{4} + {α}_{2} ) .$$

9. An apparatus for naked-eye 3D rendering based on light-field distribution, comprising:
a data acquisition unit configured to obtain parameters of a naked-eye 3D display device and real-time eye coordinates of a viewer, and to transmit the parameters and the real-time eye coordinates to a control module;
the control module configured to:
construct a light-field distribution model, a human-eye characteristic model, and a rendering model based on the parameters of the naked-eye 3D display device, wherein the rendering model includes a plurality of virtual cameras or pre-encoded video textures corresponding to different viewpoints,
generate a light-field image using the real-time eye coordinates, the human-eye characteristic model, and the rendering model, and
transmit the light-field image to the naked-eye 3D display device; and
the naked-eye 3D display device configured to render the received light-field image as a naked-eye 3D or holographic display.

10. The apparatus of claim 9, wherein the control module is further configured to determine updated rendering parameters corresponding to each eye of the viewer at a viewing position by:
constructing, based on human-eye characteristics, a human-eye characteristic model corresponding to rendering parameters associated with the virtual cameras or video textures;
performing a Fourier transform or Gaussian convolution on the human-eye characteristic model;
obtaining, based on the real-time eye coordinates, weights or convolution kernels corresponding to the rendering parameters of the virtual cameras or video textures for each eye of the viewer; and
applying the obtained weights or convolution kernels to determine the updated rendering parameters.

11. The apparatus of claim 9, wherein the control module is further configured to compute an equivalent lens pitch and an equivalent offset of an optical structure of the naked-eye 3D display device by:
determining a current viewing distance based on the real-time eye coordinates of the viewer;
obtaining the equivalent lens pitch from the current viewing distance and the light-field distribution model;
computing the equivalent offset based on horizontal and vertical coordinates of the viewer's eye in a camera coordinate system, the current viewing distance, and sub-pixel coordinates in a screen coordinate system; and
deriving a reference viewing region and an angular range associated with the reference viewing region from the equivalent lens pitch.

12. The apparatus of claim 11, wherein the control module is further configured to determine the number of virtual cameras corresponding to each eye of the viewer by counting viewpoints within the reference viewing region, wherein each viewpoint corresponds to a respective virtual camera.

13. The apparatus of claim 11, wherein the control module is further configured to update rendering parameters corresponding to each eye of the viewer at a viewing position and to arrange viewpoints within a current viewing region by:
sliding a reference viewing region by the equivalent offset to obtain the current viewing region;
sliding the angular range associated with the reference viewing region by the equivalent offset to obtain a current angular range;
aligning a center point of the viewer's eye with a center point of the current viewing region to determine a current primary viewpoint;
adjusting the rendering parameters of each virtual camera or video texture based on the current primary viewpoint, the current viewing region, and the current angular range;
rasterizing subviews of a 3D object based on the adjusted rendering parameters; and
organizing the subviews into a storage format comprising one or more of quilt images, multi-view disparity coding, or texture arrays, wherein each subview corresponds to a viewpoint within the current viewing region and is assigned a respective index.

14. The apparatus of claim 11, wherein the control module is further configured to reorder the viewpoints in the current viewing region based on a layout of the reference viewing region by:
identifying an overlapping region and a non-overlapping region between the reference viewing region and the current viewing region;
maintaining subview indices corresponding to the overlapping region unchanged;
mapping subview indices corresponding to the non-overlapping region of the current viewing region to corresponding positions in the non-overlapping region of the reference viewing region; and
reordering the viewpoints in the current viewing region based on the mapped and unchanged subview indices to generate a viewpoint map.

15. The apparatus of claim 10, wherein the control module is further configured to obtain the weights or the convolution kernels corresponding to the updated rendering parameters of the virtual cameras or video textures for each eye of the viewer at the viewing position by:
transforming the real-time eye coordinates from a visual coordinate system to an observation-space coordinate system; and
converting weights or convolution kernels associated with the rendering parameters of the virtual cameras or video textures from the visual coordinate system into corresponding weights or convolution kernels in the observation-space coordinate system.

16. A naked-eye 3D display device configured to implement the method of claim 1, comprising:
a 2D display panel or light source configured to provide 2D image data;
the optical structure of the naked-eye 3D display device configured to deliver different-angle views to left and right eyes of a viewer simultaneously, thereby enabling naked-eye 3D or holographic display; and
one or more input/output interfaces configured to transmit data required for naked-eye 3D or holographic rendering.

17. A system for naked-eye 3D rendering based on light-field distribution, comprising one or more processors and one or more non-transitory computer-readable memories coupled to the one or more processors and configured with instructions executable by the one or more processors to cause the system to perform operations comprising:
acquiring parameters of a naked-eye 3D display device, the parameters comprising 2D display parameters and optical-structure parameters of the naked-eye 3D display device;
deriving a light-field mapping relation from the optical-structure parameters;
constructing a light-field distribution model from the 2D display parameters and the light-field mapping relation;
obtaining, in real time, eye coordinates of a viewer;
computing, based on the eye coordinates and the light-field distribution model, an equivalent lens pitch and an equivalent offset of an optical structure of the naked-eye 3D display device;
determining, based on the equivalent lens pitch, a reference viewing region and an angular range associated with the reference viewing region;
determining, within the angular range, a number of virtual cameras corresponding to each eye of the viewer;
determining, within the reference viewing region and the angular range, rendering parameters associated with the virtual cameras or video textures;
arranging viewpoints corresponding to the rendering parameters within the reference viewing region;
determining, based on the equivalent offset, updated rendering parameters corresponding to each eye of the viewer at a viewing position, and arranging viewpoints within a current viewing region according to the updated rendering parameters;
reordering the viewpoints in the current viewing region based on a layout of the reference viewing region to generate a viewpoint map;
constructing a rendering model and generating a light-field image by interleaving the viewpoint map according to the rendering model; and
projecting the light-field image onto a display screen to provide naked-eye 3D rendering.

18. The system of claim 17, wherein the determining the updated render parameters comprises:
constructing, based on human-eye characteristics, a human-eye characteristic model corresponding to the rendering parameters associated with the virtual cameras or video textures;
performing a Fourier transform or Gaussian convolution on the human-eye characteristic model;
obtaining, based on the eye coordinates, weights or convolution kernels corresponding to the rendering parameters of the virtual cameras or video textures for each eye of the viewer at the viewing position; and
applying the obtained weights or convolution kernels to determine the updated rendering parameters of the virtual cameras or video textures.

19. The system of claim 17, wherein the computing the equivalent lens pitch and the equivalent offset of the optical structure of the naked-eye 3D display device comprises:
determining a current viewing distance based on the eye coordinates of the viewer;
obtaining the equivalent lens pitch from the current viewing distance and the light-field distribution model;
computing the equivalent offset based on horizontal and vertical coordinates of the viewer's eye in a camera coordinate system, the current viewing distance, and sub-pixel coordinates in a screen coordinate system; and
deriving the reference viewing region and the angular range associated with the reference viewing region from the equivalent lens pitch;
wherein the determining the number of virtual cameras corresponding to each eye of the viewer comprises counting viewpoints within the reference viewing region, each viewpoint corresponding to a respective virtual camera.

20. The system of claim 17, wherein the determining the updated rendering parameters corresponding to each eye of the viewer at the viewing position and arranging viewpoints within a current viewing region according to the updated rendering parameters comprises:
sliding the reference viewing region by the equivalent offset to obtain the current viewing region;
sliding the angular range associated with the reference viewing region by the equivalent offset to obtain a current angular range;
aligning a center point of the viewer's eye with a center point of the current viewing region to determine a current primary viewpoint;
adjusting the rendering parameters of each virtual camera or video texture corresponding to each eye of the viewer based on the current primary viewpoint, the current viewing region, and the current angular range;
rasterizing subviews of a 3D object based on the adjusted rendering parameters; and
organizing the subviews corresponding to the current viewing region according to a storage format, wherein the storage format comprises one or more of quilt images, multi-view disparity coding, or texture arrays, and each of the subviews corresponds to a viewpoint within the current viewing region and is assigned a respective index.
